(19) United States
(12) Patent Application Publication
(10) Pub. No.: US 2026/0039670 A1
(43) Pub. Date: Feb. 5, 2026

(54) DATA COLLECTION TECHNIQUES FOR SECURITY AND SAFETY OF AI-BASED APPLICATIONS

(71) Applicant: STRAIKER INC, San Jose, CA (US)

(72) Inventors: Ankur Shah, San Jose, CA (US); Sreenath Kurupati, Sunnyvale, CA (US); Vignesh Balasubramanian, Bengaluru (IN); Chandra Shekhar Mehta, Bengaluru (IN); Rahul Kumar, Bengaluru (IN)

(21) Appl. No.: 19/284,529

(22) Filed: Jul. 29, 2025

(30) Foreign Application Priority Data
Jul. 31, 2024 (IN) 202411058182

(51) Int. Cl. H04L 9/40

(52) U.S. Cl. CPC H04L 63/1416

(57) ABSTRACT

Methods and systems for artificial intelligence (AI)-based techniques for data collection techniques for security and safety of artificial intelligence (AI)-based applications are provided. A user query pertaining to one or more artificial intelligence (AI) models of a system is detected. Each of the one or more AI models are supported by services associated with the system, each running via at least one computing resource. Performance data reflecting a performance of an operation pertaining to the user query by each respective service and state data reflecting a state of the computing resource based on the performance of the operation is received. A mapping between the performance data and the state data received from each computing resource is generated. One or more of a threat detection operation or a security enforcement operation is performed based on the generated mapping.

### RELATED APPLICATIONS

This non-provisional application claims priority to Indian Provisional Patent Application No. 202411058182 filed Jul. 31, 2024, the contents of which are entirely incorporated by reference.

### TECHNICAL FIELD

Aspects and implementations of the present disclosure relate to methods and systems for data collection techniques for security and safety of artificial intelligence (AI)-based applications.

### BACKGROUND

Artificial intelligence (AI)-based systems can include a variety of services, engines, or other components that collectively support the use and deployment of AI models by downstream applications. These components may include, for example, data preprocessing services, feature extraction engines, interface engines, post-processing modules, and so forth. Each of these components plays a distinct role of enabling AI functionality and maintaining system performance. However, the distributed and interdependent nature of such system introduces potential points of failure, degradation, or misconfiguration at each component level. Accordingly, ensuring security, reliability, transparency, and accuracy of AI model usage across these various components is a significant challenge in modern AI system design.

### SUMMARY

The summary below is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes detecting a user query pertaining to one or more artificial intelligence (AI) models of a system. Each of the one or more AI models are supported by services associated with the system, each of the services running via at least one computing resource. The method further includes receiving, from each computing resource running a respective service of the services, performance data reflecting a performance of an operation pertaining to the user query by the respective service and state data reflecting a state of the computing resource based on the performance of the operation. The method further includes generating a mapping between the performance data and the state data received from each computing resource. The method further includes performing one or more of a threat detection operation or a security enforcement operation based on the generated mapping.

In some implementations, the services includes at least one of a preprocessing service that performs one or more preprocessing operations with respect to the user query, a retrieval service that retrieves data pertaining to the user query from one or more data stores, a model management service that identifies an AI model of the one or more AI model for forwarding of a prompt associated with the user query, a resource management service that performs one or more of a compute provisioning operation, a load balancing operation, or a fault tolerance operation with respect to one or more AI models, or a postprocessing service that performs one or more postprocessing operations with respect to the user query.

In some implementations, the method further includes, prior to detecting the user query, loading a code segment to each computing resource running the respective service of the plurality of services. The code segment, when executed by each computing resource, collects the performance data and the state data and transmits the collected performance data and the state data to a data store associated with a security engine. The one or more of the threat detection operations or the security enforcement operations are performed by the security engine.

In some implementations, the code segment corresponds to one or more of an extended Berkeley Packet Filter (eBPF) sensor, a proxy component, or a software development kit (SDK) component.

In some implementations, the code segment corresponds to a proxy component. The method further includes performing one or more deployment operations to deploy the code segment in a virtualized component hosted by each computing resource.

In some implementations, the code segment corresponds to a SDK component. The method further includes installing a SDK file at each computing resource.

In some implementations, the performance data and the state data is received from each computing resource of the services through an application programming interface (API) call including the performance data and the state data.

In some implementations, the performance data includes at least one of an indication of an input of the operation pertaining to the user query or an indication of an output of the operation pertaining to the user query.

In some implementations, the state data includes telemetry data reflecting at least one of one or more of a software state of the respective service or a hardware state of the computing resource before the performance of the operation, one or more of a software state of the respective service or a hardware state of the computing resource during the performance of the operation, or one or more of a software state of the respective service or a hardware state of the computing resource after the performance of the operation.

In some implementations, generating the mapping between the performance data and the state data received from each computing resource includes updating the mapping to associate the performance data and the state data received from a first computing resource running a first service of the services to the performance data and the state data received from a second computing resource running a second service of the services.

In some implementations, performing the threat detection operation based on the generated mapping includes determining, based on the generated mapping, whether one or more anomaly criteria pertaining to the performance of the operation associated with at least one respective service of the services are satisfied. The method further includes, responsive to determining that the one or more anomaly criteria are satisfied, providing a notification of that the one or more anomaly criteria are satisfied to a client device associated with an operator of the system.

In some implementations, performing the security enforcement operation includes, responsive to determining that one or more anomaly criteria pertaining to the performance of the operation associated with at least one respective service are satisfied, performing at least one of a first blocking operation to block a prompt associated with the user query from being provided as an input to the one or more AI models or a second blocking operation to block a response to the user query from being provided to a client device that provided the user query.

In some implementations, performing the security enforcement operation includes updating a data store to store a notification that one or more anomaly criteria pertaining to the performance of the operation associated with at least one respective service of the services are satisfied. The method further includes detecting a subsequent user query pertaining to the one or more AI models of the system from a client device that provided the user query. The method further includes performing at least one of a first blocking operation to block a prompt associated with the subsequent user query from being provided as an input to the one or more AI models or a second blocking operation to block a response to the subsequent user query from being provided to a client device that provided the user query.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example artificial intelligence (AI) pipeline and a first example mode of data collection at the AI pipeline, in accordance with implementations of the present disclosure.

FIG. 3 is a block diagram of an example AI pipeline and a second example mode of data collection at the AI pipeline, in accordance with implementations of the present disclosure.

FIG. 4 is a block diagram of an example AI pipeline and a third example mode of data collection at the AI pipeline, in accordance with implementations of the present disclosure.

FIG. 5 is a block diagram of an example AI pipeline and a fourth example mode of data collection at the AI pipeline, in accordance with implementations of the present disclosure.

FIG. 6 is a block diagram of an example method for data collection techniques for security and safety of AI-based applications, in accordance with implementations of the present disclosure.

FIG. 7 illustrates an example predictive system, in accordance with implementations of the present disclosure.

FIG. 8 is a block diagram illustrating an exemplary computer system, in accordance with implementations of the present disclosure.

### DETAILED DESCRIPTION

Aspects of the present disclosure relate to methods and systems data collection techniques for enabling security applications at an artificial intelligence (AI) pipeline. Advancements in large language models (LLMs) and other such types of AI models have enabled the integration of sophisticated AI capabilities (e.g., chatbots, retrieval-augmented generation (RAG) workflows, autonomous agent frameworks, etc.) directly into product-grade enterprise systems. While these integrations offer substantial improvements in productivity and user experience, they concurrently introduce challenges related to security, privacy, and operational risk. For example, such systems can be targets of prompt injection attacks that induce an AI model to disclose proprietary information or perform unauthorized actions, can inadvertently leak personally identifiable or regulated data, can be subject to model misuse that leads to the generation or prohibited, biased, or otherwise harmful content, or can be subject to system integrity degradation due to complex, opaque interactions among disparate components of the AI pipeline (e.g., vector databases, orchestration logic, model-serving gateways, external toolchains, agentic modules, etc.).

Conventional security solutions, such as network firewalls, application-layer proxies, runtime monitoring agents, and so forth, were designed to safeguard traditional web applications and microservice architectures. Such tools predominately operate at network layers %, or in some cases, at the HTTP application layer (layer 7), and as such, they lack the capability to inspect or intercept the unique semantic content, execution context, and/or multi-stage processing flows inherent to AI-based workloads. Emerging point solutions that examine only the input prompt and model output provide limited protection and fail to account for critical contextual elements, including intermediate RAG queries, model selection heuristics, and/or tool invocation sequences. These omissions significantly hinder the accuracy and reliability of detection, correlation, and enforcement mechanisms.

The complexity is further exacerbated by the deployment of AI-based applications across heterogeneous computing environments, including virtual machines, containerized services, serverless functions, and/or managed software-as-a-service (SaaS) application programming interfaces (APIs), each presenting unique challenges in terms of instrumentation and runtime observability. As conventional systems fails to offer a single telemetry-gathering mechanism that can provide comprehensive coverage across all such environments, security teams are left with fragmented visibility, persistent blind spots, and limited capacity to implement real-time, preventative controls.

Aspects of the present disclosure provide techniques for data collection techniques for security and safety of artificial intelligence (AI)-based applications. Embodiments of the present disclosure provide for the detection of each user query directed to one or more AI models of a system, the collection of granular performance data (e.g., prompt text, intermediate tool invocations, database look ups, model responses, etc.) and state data (e.g., host telemetry, system calls, resource usage, etc.) from every computing resource that is involved in servicing the query. The collected performance data and state data can be provided to a security engine of the system, and the security engine can generate a correlated mapping, representing a full execution “trace,” that stitches these multi-service events into a coherent narrative of the end-to-end transaction.

Some embodiments of the present disclosure enable the collection of the performance data and/or the state data without deployment disruption. For example, during an initialization phase of the system, the security engine can deploy a code segment to one or more computing resources of the system that run or otherwise support a service, engine, component, etc. of the AI model pipeline. The code segment can correspond to an extended Berkeley Packet Filter (eBPF) sensor, a proxy component, a software development kit (SDK) component, etc. As each computing resource performs operations that supports a detected user query, the code segment can be executed at the computing resource, which enables the collection of the performance data and the state data and the transmission of the collected performance data and state data to a data store associated with the security engine. Further details regarding such code segments are provided herein. As described herein, each code segment can be selectively deployed within a computing resource of the system (e.g., a virtual machine, a container, an external gateway, etc.) and can be integrated with little to no modification to the application code, thereby enabling broad and seamless coverage across diverse environments.

In other or similar embodiments, the security engine can receive the performance data and the state data via API calls that are triggered during the performance of operations by the computing resources in response to a user query. In such embodiments, a developer of the AI-based application may update or otherwise modify code files for the AI-based applications to include operations or instructions that trigger the API calls. Accordingly, the developer can control or otherwise define the type of data provided to the security engine and/or the frequency that data is provided to the security engine.

In yet other or similar embodiments, a reverse proxy can be positioned at the interface between the application and the AI models themselves. The reverse proxy can include a hardware component or a software component that intercepts, forwards, or otherwise manages incoming requests from clients or upstream services. The reverse proxy can intercept and monitor all (or at least a portion of) traffic sent to and/or received from the AI model and can provide, to the security engine, performance data and/or state data associated with the performance of operations pertaining to the user query based on the monitored AI traffic. In some embodiments, the reverse proxy can block specific traffic to or from the AI model, such as requests containing prohibited content or responses that violate security policies. Such embodiments allow for real-time detection and enforcement at the boundary of the AI model.

As described herein, the security engine can obtain the performance data and/or the state data from the computing resources of the system and can generate a mapping that associates the received performance data and/or the state data with the user query. Such mapping can reflect or otherwise correspond to trace data assembled for the user query. Once the mapping is generated, the security engine can perform one or more of a threat detection operation or a security enforcement operation based on the mapping. For example, the security engine can identify anomalous, malicious, or policy-violating behavior based on the mapping and, in some instances, can initiate one or more security protocols based on the identified behavior. Such security protocols can involve notification actions, including providing a notification of the violation to a client device associated with a developer or operator of the system, in some embodiments. In other or similar embodiments, such security protocols can involve enforcement actions, such as blocking AI traffic to or received from the AI model(s) (e.g., until the identified issue is resolved), throttling or terminating a suspect session, or dynamically updating policy rules to prevent recurrent abuse.

Embodiments of the present disclosure allow for any combination of data collection techniques to operate concurrently in a “hybrid” configuration across the system. For example, embodiments of the present disclosure allow for an eBPF sensor to be deployed via one or more computing resources, a SDK to be deployed via one or more additional computing resources, and/or the reverse proxy to be inserted at the interface between the application and the AI model(s). The hybrid configurations offered by the present disclosure can facilitate uniform visibility across otherwise incompatible runtimes and in-line enforcement through strategically placed proxies, all while maintaining a single correlated security vantage point by the security engine.

Implementations of the present disclosure address the above and other deficiencies by providing techniques for comprehensive and context-rich visibility and control over one or more stages of a user query directed to one or more AI models, regardless of how such user query traverses modern and/or diverse infrastructures. As described herein, a variety of diverse monitoring techniques can be implemented (e.g., in isolation or concurrently) across an AI pipeline to enable comprehensive collection of performance data and/or state data that is informative of a security status of the AI pipeline. For example, eBPF-based sensors can provide deep kernel-level insight with little to no application modification, while serverless functions can be observable through embedded SDK libraries. The reverse proxy can provide in-line blocking and rate limiting, while proxies and/or sensors enrich the security engine with low-level host telemetry. The hybrid configuration offered by some embodiments of the present disclosure harmonizes these diverse feeds into a single correlated trace, which provides the security engine with a holistic contextual data that enables the security engine to detect sophisticated prompt-injection attempts, data exfiltration, or agent misuse that would otherwise go unnoticed. Accordingly embodiments of the present disclosure offer improved system monitoring and security enforcement capabilities, while also, in some instances, preserving developer autonomy and control of the AI-based application.

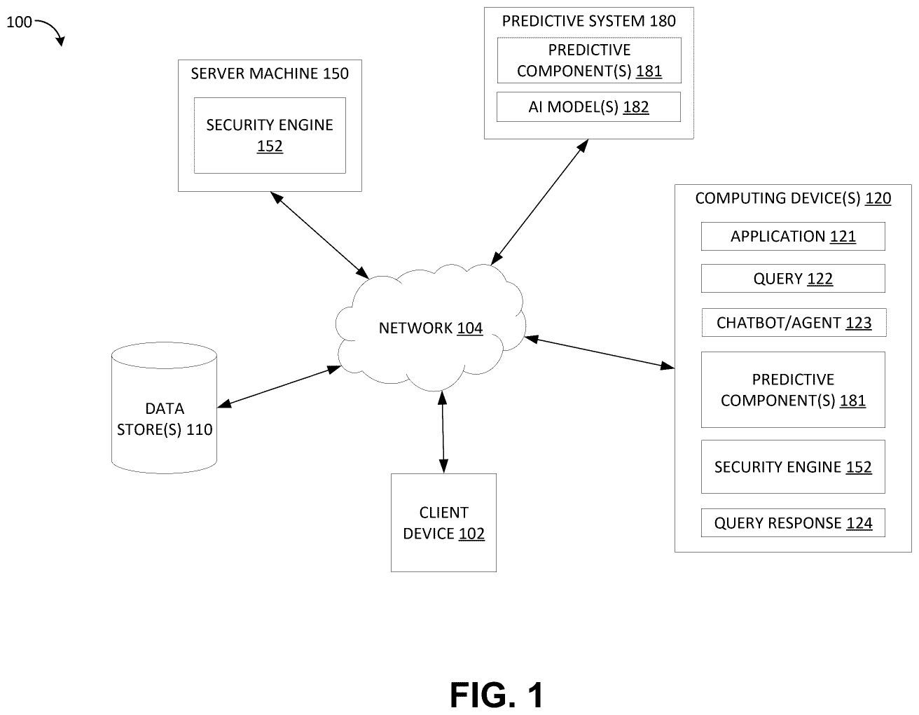

FIG. 1 illustrates an example system architecture 100, in accordance with implementations of the present disclosure. The system architecture 100 (also referred to as “system” herein) includes one or more client devices 102, one or more data stores 110, one or more computing devices 120, one or more server machines (e.g., server machine 150), and/or a predictive system 180, each connected to a network 104. In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store(s) 110 (collectively and individually referred to as data store 110 herein) can a persistent storage that is capable of storing data as well as data structures to tag, organize, and index the data. The data pertain to one or more features or functionalities of application 121, in some embodiments. For example, data store 110 can store structured and/or unstructured data that is collected, generated, or otherwise accessed by various components of system 100, including input data received from users or external systems pertaining to application 121, intermediate data generated by components or services that support application 121 (e.g., predictive component(s) 181), and/or output data obtained or otherwise produced by application 121. Data store 110 can be configured to support efficient data retrieval and updates, and may be indexed or partitioned based on application-specific criteria to optimize performance. In some embodiments, data stored at data store 110 can include information and/or metadata pertaining to an AI-based application, in accordance with embodiments described herein.

Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by computing device(s) 120 or one or more different machines (e.g., server machine 150) coupled to the computing device(s) 120 via network 104.

Computing device(s) 120 (collectively and individually referred to as computing device 120 herein) may be a desktop computer, a laptop computer, a smartphone, a tablet computer, a server, or any suitable computing device capable of performing the techniques described herein. In some embodiments, computing device 120 may be a computing device of a cloud computing platform. For example, computing device 120 may be, or may be a component of, a server machine of a cloud computing platform. In such embodiments, computing device 120 may be coupled to one or more edge devices (not shown) via network 104. An edge device refers to a computing device that enables communication between computing devices at the boundary (e.g., interface) between two networks. For example, an edge device may be connected to computing device 120, client device(s) 102, data store 110, and/or server machine 150, and/or predictive system 180 via network 104, and may be connected to one or more endpoint devices (not shown) via another network. In such example, the edge device can enable communication between computing device 120, data stores 110, server machine 150, and/or predictive system 180 and the one or more client devices 102. In other or similar embodiments, computing device 120 may be, or may be a component of, an edge device. For example, computing device 120 may facilitate communication between data stores 110, client device(s) 102, server machine 150, and/or predictive system 180 which are connected to computing device 120 via network 104, and client device(s) 102 (or one or more other user devices and/or other computing devices) that are connected to computing device 120 via another network.

Client device(s) 102 can include any computing device that enables users to access features of an application 121. For example, a client device 102 may be, or may be a component of, devices such as, but not limited to: televisions, smart phones, cellular telephones, personal digital assistants (PDAs), portable media players, netbooks, laptop computers, electronic book readers, tablet computers, desktop computers, set-top boxes, gaming consoles, autonomous vehicles, surveillance devices, and the like. In some embodiments, computing device 120 may be an edge device that connects client device(s) 102 to data stores 110, server machine 150, and/or predictive system 180. In other or similar embodiments, computing device 120 may not connect client device 102 to data stores 110, server machine 150, and/or predictive system 180, and instead may provide client device 102 with data obtained by computing device 120 from client device 102 to data stores 110, server machine 150, and/or predictive system 180. In additional or alternative embodiments, computing device 120 and client device 102 may be the same device and/or share the same or similar components.

In some embodiments, computing device 120 can host or otherwise provide access to one or more applications 121. An application 121 refers to one or more computer programs designed to carry out a specific function for an end user or another application. In some embodiments, computing device 120 can be or otherwise correspond to a platform (e.g., an application hosting platform) that hosts one or more applications 121. An instance of an application hosted by computing device 120 can be provided to a client device 102 (e.g., via network 104). An application instance refers to one or more processes of an application 121 that are performed or otherwise executed to provide access to features and/or functionality of the application 121. An application instance can be run using computing resources (e.g., processing resources, memory resources, networking resources, etc.) of a client device 102 that is providing a user with access to the application 121 and/or other computing resources of a computing environment. Computing device 120 can provide multiple client devices 102 with access to application instances of an application 121 simultaneously (or approximately simultaneously). Computing device 120 can host any number of applications 121. In other or similar embodiments, one or more of applications 121 can run on client devices 102.

In some embodiments, system 100 can include one or more computing resources (not shown). Computing resources can include one or more hardware resources, one or more software resources, etc., within a cloud computing environment. Hardware resources can include, but are not limited to, compute resources (e.g., central processing units (CPUs), graphics processing units (GPUs), tensor processing units (TPUs), field-programmable gate arrays (FPGAs), etc.), storage resources (e.g., solid state drives (SSDs), hard disk drives (HDDs), object storage systems, block storage systems, etc.), networking resources (e.g., routers, switches, firewalls, load balancers, content delivery networks (CDNs), etc.), power and/or cooling systems, and so forth. Software resources can include, but are not limited to, virtualization resources (e.g., hypervisors, virtual machines, containers, etc.), operating system (OS) resources, middleware resources, cloud management tools, database management systems, artificial intelligence (AI) and/or machine learning (ML) frameworks, development tools, and so forth.

Some embodiments and examples of the present disclosure refer to an engine (e.g., a security engine, etc.). An engine refers to software or hardware that is designed to perform a specific set of operations or tasks within a system (e.g., system 100). An engine can be implemented as a standalone software component (e.g., code or code segment), a standalone hardware component (e.g., computing resource), or as part of a larger system architecture. The engine can encapsulate logic, algorithms, and/or processing workflows that are implemented or otherwise applied to carry out its designated function.

In some embodiments, application 121 can be an AI-based application that may incorporate one or more AI models 182 or AI-based techniques to perform tasks. AI-based applications may leverage machine learning, natural language processing, computer vision, or other AI technologies to analyze data, make predictions, generate content, automate decision-making, and so forth. Examples of AI-based applications include, but are not limited to, a virtual assistant application that understands and responds to user commands (e.g., voice commands), an image recognition application that identifies objects in images or videos, a recommendation application that provides recommendation based on given information, a fraud detection application that monitors data (e.g., transactions) for suspicious activity, a language model that generates human-like text or audio in response to user queries, and so forth.

A query 122 refers to a user-generated input (e.g., to application 121) that represents a request for information, assistant, or an action. A user of client device 102 can interact with a chatbot/agent 123 of application 121 through various interfaces (e.g., a text-based chat window, a voice input, a graphical user interface GUI, etc.) of client device 102 to provide the query 122. In an illustrative example, a user of client device 102 can provide to chatbot/agent 123 the command to “Generate an email asking when the next meeting should be scheduled” via an interface of client device 102. Such command can be captured and structured as query 122 that is received by chatbot/agent 123 (e.g., via network 104, etc.). Chatbot/agent 123 can receive the query 122 and interpret it using natural language processing (NLP) techniques, in some embodiments. As described herein, chatbot/agent 123 can coordinate with one or more components (e.g., predictive component(s) 181), services, and/or tools to provide a prompt associated with the query 122 as an input to an AI model 182. Chatbot/agent 123 may obtain an output of the AI model 182 (e.g., directly from AI model 182, from a component, service, tool, etc.) and provide the output to client device 102 for presentation to the user (e.g., via the interface). Such output is referred to herein as a query response 124.

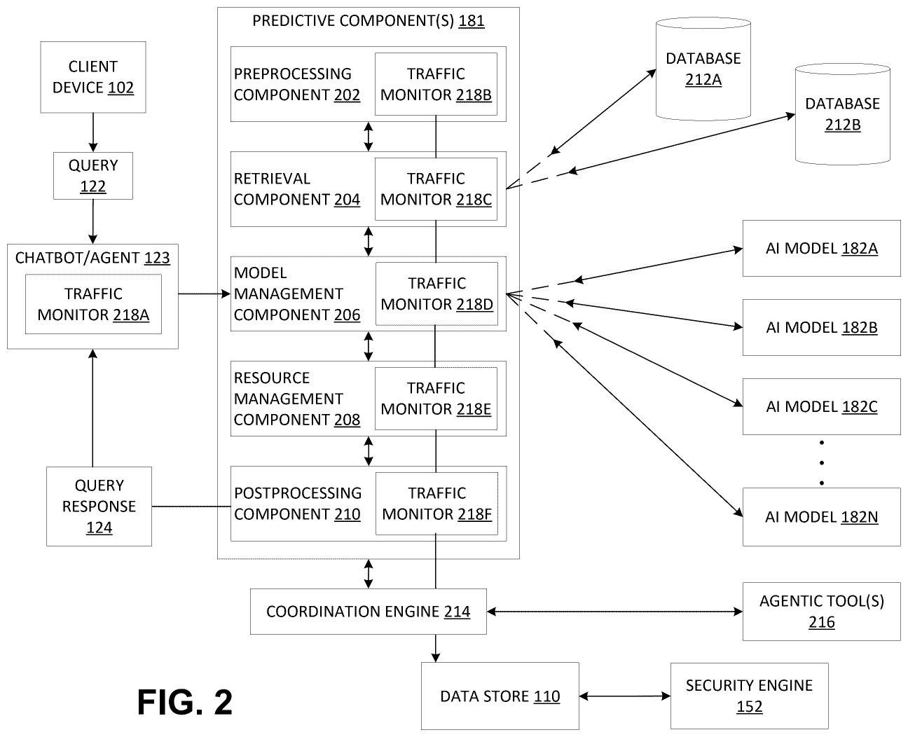

As illustrated in FIG. 1, computing device(s) 120 can include a security engine 152 that performs operations associated with data handling, authorization, and/or integrity of AI interactions. As described herein, security engine 152 may perform threat detection operations that involve the continuous or periodic monitoring of activities across system 100 relating to AI model(s) 182 and/or interactions between application 121 and/or AI model(s) 182 and surface vulnerabilities detected based on the monitoring. Additionally or alternatively, security engine 152 may perform security enforcement operations that involve blocking or otherwise addressing malicious behaviors detected based on continuous or periodic monitoring of activities and interactions associated with AI model(s) 182. As described herein, embodiments of the present disclosure provide various techniques that can be implemented at system 100, or a system like or similar to system 100, for collecting data that can be used by security engine 152 to perform the threat detection and/or security enforcement operations. Details regarding such data collection are provided herein with respect to FIGS. 2-6 below.

It should be noted that although FIG. 1 illustrates security engine 152 as part of computing device 120, in additional or alternative embodiments, one or more portions or components of security engine 152 can reside and/or be executed at client device(s) 102. In other or similar embodiments, one or more components of security engine 152 can reside on one or more server machines that are remote from computing device 120. In an illustrative example, security engine 152 can reside at server machine 150. It should be noted that in some other implementations, the functions of computing device 120, server machine 150, and/or predictive system 180 can be provided by more or a fewer machines. For example, in some implementations, components and/or modules of computing device 120, server machine 150, and/or predictive system 180 may be integrated into a single machine, while in other implementations components and/or modules of any of computing device 120, server machine 150, and/or predictive system 180 may be integrated into multiple machines. In addition, in some implementations, components and/or modules of server machine 150, and/or predictive system 180 may be integrated into computing device 120.

In general, functions described in implementations as being performed computing device 120, server machine 150, and/or predictive system 180 can also be performed on the client devices 102A-N in other implementations. In addition, the functionality attributed to a particular component can be performed by different or multiple components operating together. Computing device 120 can also be accessed as a service provided to other systems or devices through appropriate application programming interfaces, and thus is not limited to use in websites.

FIG. 2 is a block diagram of an example artificial intelligence (AI) pipeline and a first example mode of data collection at the AI pipeline, in accordance with implementations of the present disclosure. As described above, a user of client device 102 can provide a query 122 including a request or command pertaining to an operation associated with an AI model 182 via an interface of client device 102. The query 122 can be received by chatbot/agent 123, which can act as a front-end conversational interface between the user and predictive component(s) 181.

In some embodiments, chatbot/agent 123 can interpret the query 122 and route the query 122 to a predictive component 181 associated with the query 122. In some embodiments, chatbot/agent 123 can interpret an intent of the query 122 (e.g., using NLP techniques). In some embodiments, chatbot/agent 123 may determine an intent of query 122 by performing one or more operations to tokenize parse the query 122 and provide the tokenized query 122 as an input to a classification model (e.g., a trained neural network or a fine-tuned transformer). An output of the classification model can include an indication of a category of the query (e.g., indicated by predefined intent labels). In some embodiments, chatbot/agent 123 can perform one or more pattern recognition operations or keyword matching operations to determine a pattern and/or keywords of the query 122.

Chatbot/agent 123 can additionally or alternatively determine a context of the query 122 and, based on the determined context, may route the query 122 to an appropriate predictive component 181 pertaining to the query 122 (e.g., based on a set of rules, based on learned intelligence, etc.). In some embodiments, chatbot/agent 123 may determine a context of query 122 based on historical data associated with the user that provided the query and/or the client device 102. The historical data can include historical conversation data representing a conversation between the user and chatbot/agent 123 (e.g., during a current conversational session and/or a prior conversational session). In some embodiments, chatbot/agent 123 can obtain one or more contextual embeddings based on the historical data (e.g., based on one or more outputs of an embedding generation engine, etc.). In some embodiments, the historical data can include additional information, such as user account information, session metadata transactional data, and so forth.

As illustrated by FIG. 2, an AI pipeline can include one or more predictive components 181 that are configured to perform various tasks associated with the AI pipeline. For example, predictive components 181 can include, but are not limited to, preprocessing component 202, retrieval component 204, model management component 206, resource management component 208, and/or postprocessing component 210. It should be noted that although some embodiments or examples of the present disclosure refer to such predictive components 181, such embodiments or examples can be applied to other types of components of an AI pipeline. Further, some features or functionalities of components 181 described herein may be performed by multiple components and/or alternative embodiments. Such components 181 are provided for purposes of example and explanation only and are not intended to be limiting. Finally, features or functionalities of component(s) 181 may be performed or otherwise associated with services, microservices, engines, etc. of an AI pipeline and/or system 100.

Preprocessing component 202 can perform one or more preprocessing operations to prepare an incoming query 122 for efficient and accurate processing by AI model(s) 182. Preprocessing operations can include, but are not limited to, text normalization operations (e.g., lowercasing, removing special characters, etc.), tokenization operations (e.g., generating or otherwise obtaining tokens representing features of query 122, correction operations (e.g., spell correct operations, noise reduction operations, etc.), language detection operations, and so forth. In some embodiments, preprocessing component 202 can reformat query 122 into a structured prompt (e.g., based on an intent or context of the query 122). In some embodiments, preprocessing component 202 can receive an intent and/or context of query 122 from chatbot/agent 123. In other or similar embodiments, preprocessing component 202 can determine the intext and/or context of query 122 in accordance with similar techniques described with respect to chatbot/agent 123 above.

Retrieval component 204 can perform one or more retrieval operations to identify and retrieve information associated with query 122. In some embodiments, the one or more retrieval operations can be operations of a Retrieval Augmented Generation (RAG) process. A RAG process is a technique that combines information retrieval with natural language generation to obtain informed and contextually accurate responses using AI model(s) 182. In some embodiments, retrieval component 204 can obtain one or more vectors representing a semantic meaning of query 122. Retrieval component 204 can obtain the vectors from preprocessing component 202, in some embodiments. In other or similar embodiments, retrieval component 204 can obtain the vectors based on one or more outputs of an embedding model (e.g., text embedding models, sentence transformers, etc.). Upon obtaining the vector(s), retrieval component 204 may access one or more databases 212 (e.g., database 212A, database 212B, etc.) and retrieve information corresponding to the vector(s). Database(s) 212 can include an external knowledge source and can store, for example, a document corpus, an indexed dataset, etc. In some embodiments, database(s) 212 can include a vector database, which is a specialized type of database designed to store, index, and/or search high-dimensional vector representations of data, such as text, images, audio, or other complex information. Retrieval component 204 can perform one or more operations to parse database(s) 212 and identify vectors or embeddings of the database that match or otherwise correspond to the vector(s) associated with query 122. The operations can include, for example, similarity search operations (e.g., a nearest neighbor operation, an approximate nearest neighbor operation, etc.) that, when applied to a vector database, outputs a indication of one or more vectors that are most similar to the vector(s) of query 122 based on distance metrics such as cosine similarity or Euclidean distance. Upon determining that one or more similarity criteria are satisfied (e.g., a degree of similarity between the vector(s) of query 122 and a vector of database(s) 212 exceeds a threshold degree of similarity), retrieval component 204 can extract the vector from database(s) 212 and/or can obtain information associated with the vector from database(s) 212. It should be noted that other types of techniques can be applied to identify and retrieve information from database(s) 212 by retrieval component 204.

Model management component 206 can perform one or more operations associated with managing interactions with AI model(s) 182. In some embodiments, model management component 206 can maintain a data structure (e.g., a registry, a log, etc.) of available AI models 182 to application 121. In some embodiments, each entry of the data structure can include a model identifier field (e.g., including a unique identifier associated with a respective AI model 182), a model type field (e.g., indicating a type of the respective AI model 182), a location field (e.g., indication a location where the model is hosted), an input/output schema field (e.g., indicating an expected format of inputs and/or outputs of the respective AI model 182), a usage constraints field (e.g., indicating one or more usage constraints associated with one or more computing resources of the respective AI model 182, and so forth). In some embodiments, model management component 206 can identify an AI model 182 using the data structure that is best suited to handle the request (e.g., based on user intent, model capabilities, load balancing, cost optimization, etc.) and can forward a prompt associated with the query 122 to such AI model 182.

As illustrated by FIG. 2, the AI pipeline can include multiple different AI models 182. In some embodiments, each AI model 182 can have a distinct type or a distinct source. A type of an AI model refers to a type of operation or task that can be performed by the AI model 182. A source of the AI model refers to a source or entity that manages (e.g., trains, hosts, etc.) the AI model 182. In an illustrative example, a first AI model 182A can include a natural language model that is trained to perform tasks that involve natural language understanding, such as the generation of human-like text, summarization, translation, complex reasoning, etc.). The first AI model 182A can be hosted or otherwise supported by system 100 or another system. A second AI model 182A can include an AI model that is self-hosted (e.g., by system 100). A third AI model 182B can be an open source software (OSS) model that leverages open-source pre-trained models on platforms that are available to users or services (e.g., in accordance with an OSS license). As described above, model management component 206 can identify a model 182 for routing of a prompt associated with query 122.

Resource management component 208 can provide or otherwise identify computing resources that support AI model(s) 182 and/or other components of the AI pipeline. In some embodiments, the AI pipeline can be included in a serverless execution environment that provides on-demand computational resources that execute discrete units of code in response to events. Such computational units may be stateless and ephemeral, meaning that they only exist for the duration of their execution and do not retain memory between invocations. Resource management component 208 may provide or otherwise represent the code or computing resources that execute the code of the serverless environment. In some embodiments, resource management component 208 can perform or otherwise route features or functionalities associated with other components 181 in accordance with a serverless architecture.

Postprocessing component 210 can perform one or more postprocessing operations with respect to one or more outputs of AI model(s) 182. The postprocessing operations can refine, transform, or augment the raw output of the AI model(s) 182 into a form that can be understood by a user of client device 102. The postprocessing operations can include, but are not limited to, content moderation/filtering operations (e.g., to check for inappropriate or undesirable content output from the model 182), formatting or restructuring operations (e.g., converting raw generated text in to a specified format for presentation via an interface of client device 102), a summarization or condensation operation (e.g., to summarize or extract key points of the AI model output to fit a specific length constraint or user need), a fact-checking or grounding operation (e.g., to cross-reference statements generated by the AI model 182 with a trusted knowledge database or external APIs to ensure accuracy and prevent “hallucinations”), language translation operations (e.g., to translate the model output into a target language associated with the user or client device 102), and so forth.

In some embodiments, application 121 may be or otherwise correspond to an agentic AI application. An agentic AI application represents a class of predictive components that are designed to autonomously perceive its environment, reason about its observations, formulate goals, and take actions to achieve those goals, often through iterative cycles of planning and execution. In some embodiments, the AI pipeline may, optionally, include a coordination engine 214 and/or one or more agentic tools 216 that support the agentic AI application. In some embodiments, the coordination engine 214 can perform operations associated with a model context protocol (MCP), which provides a standardized interface between chatbot/agent 123 and the agentic tool(s) 216. Agentic tool(s) 216 can include external functions, APIs, or specific capabilities that can be invoked by chatbot/agent 123 to perform actions or retrieve information beyond its internal knowledge. Example tools 216 can include, but are not limited to, a search engine tool to find information online, a calendar tool to schedule appointments, a database tool to query or update data, a code execution tool to run and test code, a messaging tool to send messages, and so forth. Coordination engine 214 can provide chatbot/agent 123 with access to a standard definition and/or structure indicating how chatbot/agent 123 can request actions or data associated with tool(s) 216. Coordination engine 214 can also or alternatively exchange data with tool(s) 216 which is used or to create or otherwise update the standard definition and/or structure for communication between chatbot/agent 123 and tool(s) 126.

As described herein, security engine 152 can obtain performance data and/or state data from computing resources that support components of the AI pipeline and can generate a mapping that associates the performance data and/or the state data with a user query. Performance data can represent or otherwise be associated with a performance of an operation pertaining to a query 122 by one or more computing resources of system 100. State data can represent or otherwise be associated with a state of the computing resource before, during, and/or after the performance of the operation. Example performance data can include, but is not limited to, prompt text, intermediate tool invocations, database look ups, model responses, and so forth. Example state data can include, but is not limited to, host telemetry, system calls, resource usage, and so forth. A threat detection operation can include an operation that involves detecting or otherwise identifying anomalous, malicious, or policy-violating behavior based on a mapping the performance data and/or the state data obtained by the security engine 152. A security enforcement operation can include an operation to block AI traffic to or received from the AI model(s), throttling or terminating a suspect session, or dynamically updating policy rules to prevent recurrent abuse (e.g., detected for a client device 102).

Security engine 152 can collect performance data and/or state data associated with a query 122 in accordance with one or more techniques. In some embodiments, security engine 152 can collect performance data and/or state data from one or more traffic monitors 218 included at one or more computing resources of the AI pipeline. A traffic monitor 218 refers to an element designed to observe and/or collect performance data and/or state data at a respective computing resource or group of computing resources that supports a component or portion of the AI pipeline. As illustrated by FIG. 2, a traffic monitor 218 can be included or otherwise installed at a computing resource that supports chatbot/agent 123, preprocessing component 202, retrieval component 204, model management component 206, resource management component 208, and/or postprocessing component 210. It should be noted that although FIG. 2 depicts respective traffic monitors (e.g., traffic monitors 218A-218F) included at computing resource(s) that support chatbot/agent 123, preprocessing component 202, retrieval component 204, model management component 206, resource management component 208, and/or postprocessing component 210, traffic monitors can be included at additional or fewer computing resources. Further, a traffic monitor 218 can be included at any component or engine of the AI pipeline depicted by FIGS. 2-5.

In some embodiments, a traffic monitor 218 can include an extended Berkeley Packet Filter (eBPF) that is injected into the kernel of a hosting compute instance (e.g., virtual machine, container, etc.) of a computing resource associated with a respective component or engine of the AI pipeline. In such embodiments, the eBPF sensor may be installed or otherwise attached to a kernel tracepoint or socket hook that coincides with AI service traffic. In some embodiments, security engine 152 can cause the eBPF sensor to be installed at one or more computing resources of the AI pipeline by loading a pre-compiled or just-in-time (JIT) compiled eBPF byte-code object into the kernel via a system call (e.g., a bpf( ) system call). Upon installation of the eBPF sensor, the code for the eBPF sensor can be executed by the respective computing resource(s), which can involve registering kprobes and/or uprobes to intercept ingress and/or egress buffers associated with intra-pipeline service calls. Accordingly, in some embodiments, user-space application code may not be modified, making such deployment of the traffic monitor “zero-touch” from the application developer perspective.

Upon receipt of a query 122, chatbot/agent 123 and/or component(s) 181 can perform operations associated with the query 122, as described above. The eBPF sensor can capture data associated with the performance of the operations, such as request and response payloads, which can include prompts, embeddings, and/or model outputs. The eBPF sensor can also collect data including contextual metadata, such as timestamp data, source/destination identifiers, process context, container labels, cryptographic session identifiers, and so forth. In some embodiments, the eBPF sensor can also collect data including system call level telemetry data. The eBPF sensor can provide the collected data to data store 110. Security engine 152 can generate a mapping between the data collected by each eBPF sensor during the performance of operations associated with a respective query 122 and can perform the treat detection operation and/or the security enforcement operation based on the generated mapping, as described herein.

In other or similar embodiments, a traffic monitor 218 can include a proxy. A proxy can include an element or a component (e.g., a software element, a hardware element, a firmware element, etc.) that acts as an intermediary for requests between components and engines of the AI model pipeline. In some embodiments, a proxy binary can be loaded at chatbot/agent 123 and/or one or more predictive components 181 of the AI pipeline, either as a sidecar container (e.g., in accordance with a traditional service mesh pattern) or as a sidecarless process injected into the host network namespace. A sidecar container refers to a secondary container that runs along a main application container at a set or group of computing resources. In some embodiments, the sidecar container and the main application container can share the same network namespace and storage volumes, allowing them to communicate effectively and share resources. The sidecar proxy can intercept traffic entering and leaving the main container. If the proxy is injected as a sidecarless process, the proxy may not be directly co-located within the same set or group of computing resources as the application. Instead, the proxy may run on a host node, intercepting traffic for multiple resources of that node, in some embodiments. In other or similar embodiments, the proxy can be implemented as a centralized proxy service that sits outside of the individual application instances. In yet other or similar embodiments, the proxy logic can be directly embedded as code within the application itself. Once the proxy is installed (e.g., as a sidecar container and/or as a sidecarless process), intra-node traffic can be rerouted (e.g., transparently) through the proxy through iptables rules and/or cgroup-based redirection. Upon receiving the rerouted traffic, the proxy can provide the traffic as performance data and/or state data to data store 110, as described above. Security engine 152 can generate a mapping between the performance data and/or state data received from each proxy, which can represent the trace associated with query 122, as described herein.

In other or similar embodiments, a traffic monitor 218 can include a SDK library. In such embodiments, a developer of application 121 can cause a language-specific library into the application code, where the library exposes wrapper functions or decorators that instrument AI-related calls. The SDK can be obtained via a package manager and linked to a component or element of the AI pipeline at build time. At application start-up, the SDK can establish a secure control channel to data store 110 and/or security engine 152 and can register instance metadata (e.g., service name, version, environment tags, etc.). Upon receipt of query 122, the SDK can access high-fidelity logical context, such as functional parameters, user identifiers, and/or business-domain attributes and provide such data as performance data and/or state data to data store 110, as described above. Security engine 152 can generate the mapping based on the performance data and/or state data collected from each SDK during service to query 122, as described herein.

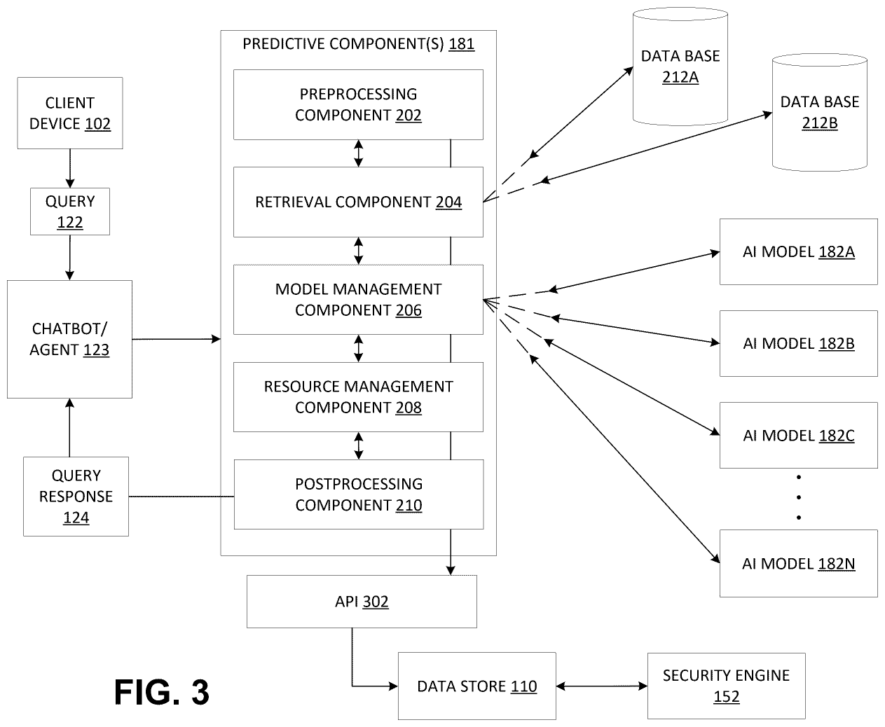

FIG. 3 is a block diagram of an example AI pipeline and a second example mode of data collection at the AI pipeline, in accordance with implementations of the present disclosure. The AI pipeline of FIG. 3 can perform operations to obtain a query response 124 to a query 122 in accordance with embodiments described above. In some embodiments, security engine 152 can obtain performance data and/or state data associated with operations associated with query 122 based on an API 302. In such embodiments, an application developer can update application code of application 121 to make explicit calls to API 302, passing performance data and/or state data to API 302 as part of the payload. The application developer can specify within the application code points in the application where data should be collected and to invoke the API with the performance data and/or the state data via API calls. The API endpoint (e.g., API 302) can receive and process data transmitted via the API calls, which can include request/response payloads, user identifiers, and/or other contextual data, as described herein. The comprehensiveness of the data can be specified by the application developer. The API 302 can store the performance data and/or the state data at data store 110, as described above. Security engine 152 can generate a mapping between an identifier for the query 122 and the data stored at data store 110 by API 302. Security engine 152 can generate the mapping based on the performance data and/or the state data received from API 302, as described herein.

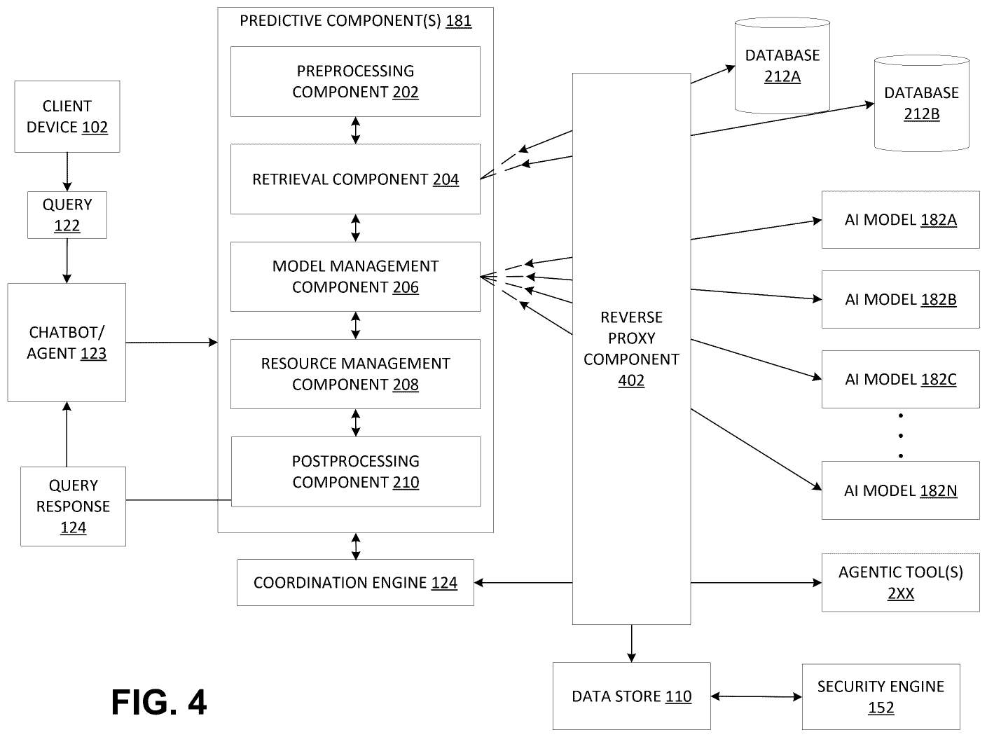

FIG. 4 is a block diagram of an example AI pipeline and a third example mode of data collection at the AI pipeline, in accordance with implementations of the present disclosure. The AI pipeline of FIG. 4 can perform operations to obtain a query response 124 to a query 122 in accordance with embodiments described above. In some embodiments, security engine 152 can obtain performance data and/or state data associated with operations associated with query 122 based on a reverse proxy 402. A reverse proxy 402 refers to an element that acts as an intermediary computing resource that sits at an interface of one or more components of the AI pipeline (e.g., AI model(s) 182) and forwards client requests to such components. For example, when retrieval component 204 forwards a request (e.g., a RAG request) to a database 212, the request can be sent to an address of reverse proxy 402, which can decide which database 212 to send the request to (e.g., based on data or metadata of the request). The reverse proxy 402 can obtain a response from the database 212 and send it to retrieval component 204. In another example, when model management component 206 forwards a prompt to an AI model 182, component 206 can sent the prompt to the address of reverse proxy 402, which can decide which model 182 to send the prompt to. The reverse proxy 402 can obtain a response form the AI model 182 and send it to model management component 206 and/or post-processing component 210.

As described above, requests from components of AI pipeline can be forwarded through reverse proxy 402. Reverse proxy 402 can capture the request payloads and responses that pass through it, providing visibility into the data exchanged with internal and/or external AI services. Reverse proxy 402 can provide the capture data to data store 110 as performance data and/or state data, which can be used to generate the mapping by security engine 152, as described above. As reverse proxy 402 intercepts requests and responses between components, reverse proxy 402 can block requests or responses that are identified to violate a security protocol, as described herein. For example, security engine 152 may determine, based on the mapping, that a security protocol associated with application 121 is violated. In such embodiments, security engine 152 can transmit an instruction to reverse proxy 402 to block requests or responses in view of the violation.

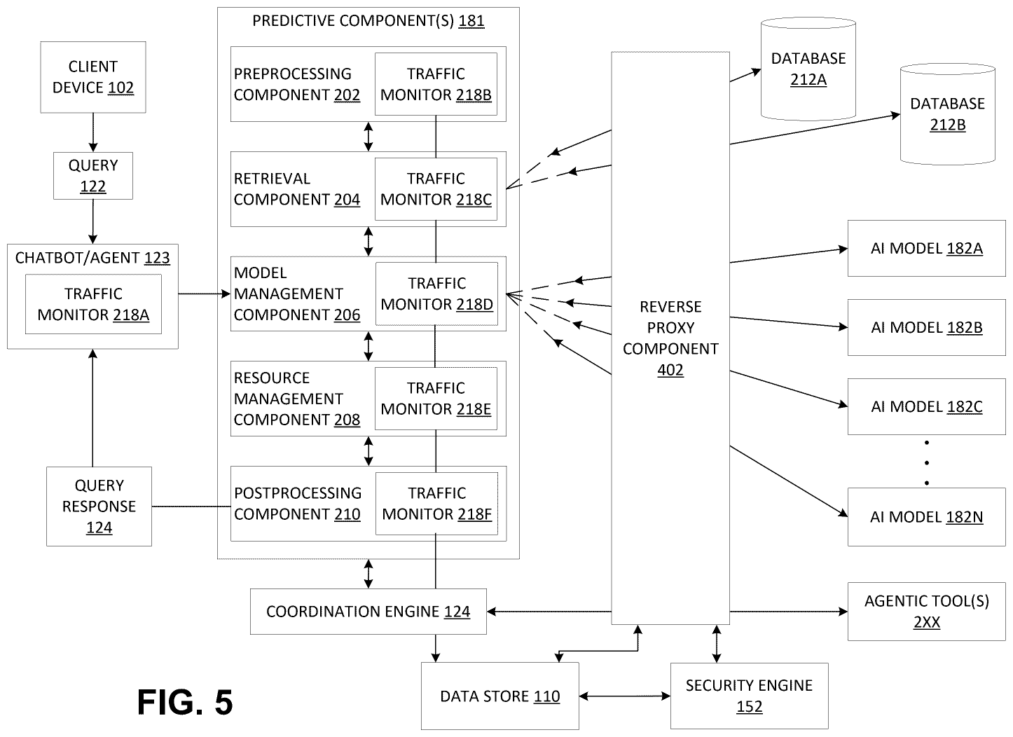

FIG. 5 is a block diagram of an example AI pipeline and a fourth example mode of data collection at the AI pipeline, in accordance with implementations of the present disclosure. The AI pipeline of FIG. 5 can perform operations to obtain a query response 124 to a query 122 in accordance with embodiments described above. As illustrated by FIG. 5, the AI pipeline can support simultaneous activation of multiple data collection modes across components of the AI pipeline. For example, a traffic monitor (e.g., an eBPF sensor) can be installed at computing resources for one or more predictive components 181 and/or chatbot/agent 123. Another traffic monitor (e.g., SDK) can be installed at resource management component 208 (e.g., to instrument serverless functions). A reverse proxy 402 may perform last-mile enforcement to calls for model hosts. Although not illustrated by FIG. 5, API 302 can be used in conjunction with the other modes to provide additional data collection at specific points in the application.

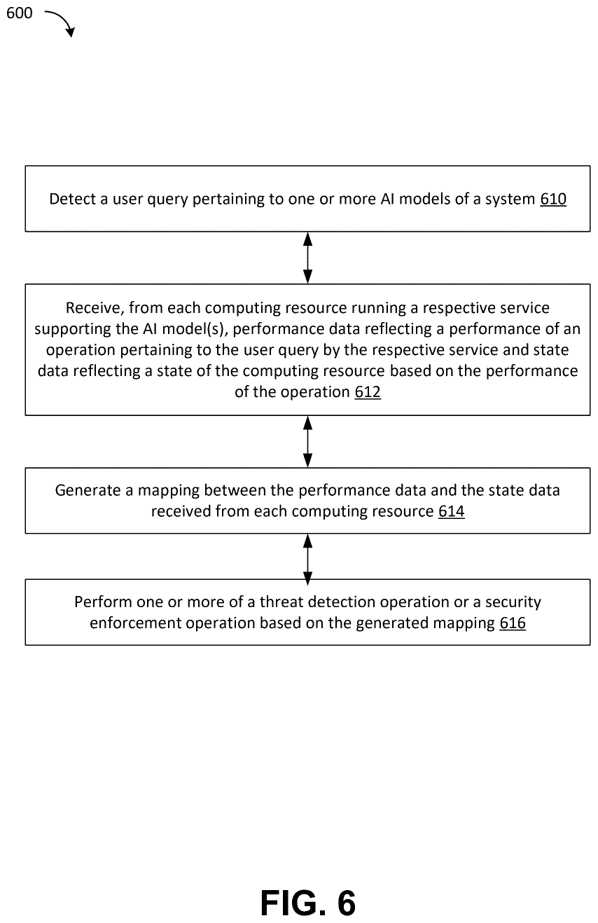

FIG. 6 is a block diagram of an example method for data collection techniques for security and safety of AI-based applications, in accordance with implementations of the present disclosure. In some embodiments, method 600 can be performed by computing device 102. For example, one or more operations of method 600 can be performed by one or more components of security engine 152, in some embodiments. Method 600 may be performed by one or more processing units (e.g., CPUs and/or GPUs), which may include (or communicate with) one or more memory devices. In at least one embodiment, method 600 may be performed by multiple processing threads (e.g., CPU threads and/or GPU threads), each thread executing one or more individual functions, routines, subroutines, or operations of the method. In at least one embodiment, processing threads implementing method 600 may be synchronized (e.g., using semaphores, critical sections, and/or other thread synchronization mechanisms). Alternatively, processing threads implementing method 600 may be executed asynchronously with respect to each other. Various operations of method 600 may be performed in a different order compared with the order shown in FIG. 6. Some operations of the methods may be performed concurrently with other operations. In at least one embodiment, one or more operations shown in FIG. may not always be performed.

At block 610, processing logic detects a user query pertaining to one or more AI models of a system. The user query can correspond to or otherwise include query 122, as described herein. At block 612, processing logic receives, from each computing resource running a respective service supporting the AI model(s), performance data reflecting a performance of an operation pertaining to the user query by the respective service and state data reflecting a state of the computing resource based on the performance of the operation. Security engine 152 can receive performance data and/or state data in accordance with one or more modes described with respect to FIGS. 2-5, as described above.

At block 614, processing logic generates a mapping between the performance data and the state data received from each computing resource. In some embodiments, security engine 152 can collect performance data and/or state data from multiple traffic monitors 218, as described above. In such embodiments, security engine 152 can generate a mapping between the performance data and/or state data collected from each traffic monitor 218 and can update the mapping to include an identifier associated with query 122. In other or similar embodiments, security engine 152 can obtain the performance data and/or state data from API 302, reverse proxy 402, etc. and can generate the mapping between the identifier associated with query 122 and the performance data and/or state data.

At block 616, processing logic performs one or more of a threat detection operation or a security enforcement operation based on the generated mapping. In particular, security engine 152 may perform the threat detection operation by analyzing the mapped performance and state data to identify anomalies, patterns, or behaviors indicative of potential security threats, such as unauthorized access attempts, data exfiltration, or distributed denial-of-service (DDoS) attacks. By correlating the performance data (e.g., resource utilization, network traffic patterns) with the state data (e.g., system status, active processes) for each computing resource or traffic monitor, the security engine 152 can detect deviations from normal operation that may signal a security incident. Similarly, the security enforcement operation can leverage the generated mapping to apply targeted security policies or mitigation actions. For example, if the mapping reveals that a particular query 122 is associated with suspicious activity on a specific resource, the security engine 152 can automatically enforce access controls (e.g., via reverse proxy 402), isolate affected resources, or trigger alerts to administrators. This mapping-driven approach enables dynamic and context-aware threat detection and response, improving the overall security posture of the system.

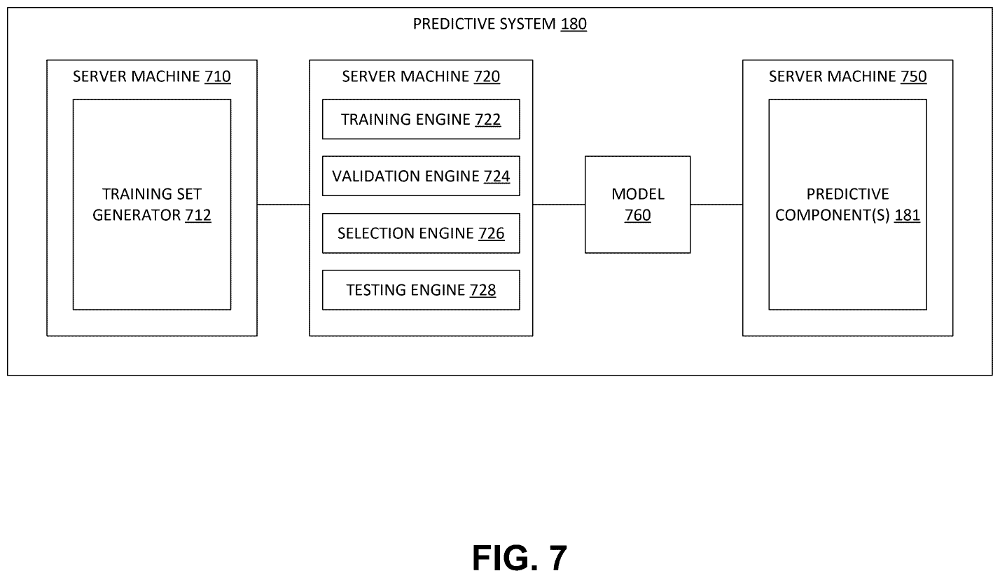

FIG. 7 illustrates an example predictive system, in accordance with implementations of the present disclosure. As illustrated in FIG. 7, predictive system 180 can include a training set generator 712 (e.g., residing at server machine 710), a training engine 712, a validation engine 724, a selection 726, and/or a testing engine 728 (e.g., each residing at server machine 720), and/or a predictive component 752 (e.g., residing at server machine 750). Training set generator 712 may be capable of generating training data (e.g., a set of training inputs and a set of target outputs) to train one or more AI model 760.

In some embodiments, one or more of AI model(s) 760 (e.g., AI model 182) can include a general purpose model that is trained to perform a wide variety of tasks. In such embodiments, training set generator 712 can generate a training data set for training AI model 182 based on a corpus of textual data, audio data, video data, and so forth. The corpus can include a wide array of information gathered from numerous sources, including publicly available web pages (e.g., blogs, forums, news sites, academic papers, online encyclopedias, etc.), books and literature, social media, research papers, public datasets, and so forth. Training set generator 712 can extract features from data of the corpus and can transform the extracted features into a format that the AI model 182 can interpret. In some embodiments, training set generator 712 can perform one or more tokenization operations (e.g., to break down the textual data, audio data, video data, etc. into smaller units called tokens), one or more normalization operations (e.g., to convert the tokens into a common format and/or a format that can be handled by the AI model 182), one or more noise removal operations (e.g., to remove or filter out unwanted data or metadata), and/or one or more data formatting operations (e.g., to structure the tokens uniformly and indicate contextual windows between tokens indicating dependencies between tokens). In some embodiments, training set generator 712 can obtain annotation data for the tokens obtained based on the data of the corpus. Annotation data can include an indication of a classification associated with the token. In some embodiments, the annotation data can be provided by human annotators or according to other annotation techniques. Training set generator 712 can update the training data set to include the extracted features, the generated tokens, and/or the annotation data. As described below, training engine 722 can use the training data to perform the wide range of tasks.

Training engine 722 can train an AI model 760 using the training data from training set generator 712, as described above. The model 760 can refer to the model artifact that is created by the training engine 722 using the training data that includes training inputs and/or corresponding target outputs (correct answers for respective training inputs). The training engine 722 can find patterns in the training data that map the training input to the target output (the answer to be predicted), and provide the model 760 that captures these patterns. The model 760 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like.

In some embodiments, training engine 722 can first pre-train the AI model 760 on a corpus of text (e.g., generated by or accessible to training set generator 712 and/or training engine 722) to create a foundational model, and afterwards fine-tuned on more data pertaining to a particular set of tasks to create a more task-specific, or targeted, model. The foundational model can first be pre-trained using a corpus of text that can include text context in the public domain, licensed content, and/or proprietary content. Such a pre-training can be used by the model to learn broad language elements including general sentence structure, common phrases, vocabulary, natural language structure, and any other elements commonly associated with natural language in a large corpus of text. In some embodiments, this first, foundational model can be trained using self-supervision, or unsupervised training on such datasets.

In some embodiments, the AI model 760 can then be further trained and/or fine-tuned on organizational data, including proprietary organizational data. The AI model 760 can also be further trained and/or fine-tuned on organizational data associated with a virtual meeting 160 and/or other documents, including proprietary organizational data associated with a virtual meeting 160 and/or other documents.

In some embodiments, the second portion of training, including fine-tuning, may be unsupervised, supervised, reinforced, or any other type of training. In some embodiments, this second portion of training may include some elements of supervision, including learning techniques incorporating human or machine-generated feedback, undergoing training according to a set of guidelines, or training on a previously labeled set of data, etc. In a non-limiting example associated with reinforcement learning, the outputs of the AI model 760 while training may be ranked by a user, according to a variety of factors, including accuracy, helpfulness, veracity, acceptability, or any other metric useful in the fine-tuning portion of training. In this manner, the AI model 760 can learn to favor these and any other factors relevant to users within an organization, or associated with a virtual meeting, when generating a response. In such a way, a foundational model can be further trained to perform within a virtual meeting, and provide useful information, as well as help to accomplish useful tasks associated with the virtual meeting.

In some embodiments, the AI model 760 may include one or more pre-trained models, or fine-tuned models. In a non-limiting example, in some embodiments, the goal of the “fine-tuning” may be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

In one embodiment, the AI model 760 may be one or more of decision trees, random forests, support vector machines, or other types of machine learning models. In one embodiment, the AI model 760 may be one or more artificial neural networks (also referred to simply as a neural network). The artificial neural network may be, for example, a convolutional neural network (CNN) or a deep neural network. In one embodiment, processing logic performs supervised machine learning to train the neural network.

Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). The neural network may be a deep network with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

In some embodiments, the AI model 760 may be one or more recurrent neural networks (RNNs). An RNN is a type of neural network that includes a memory to enable the neural network to capture temporal dependencies. An RNN is able to learn input-output mappings that depend on both a current input and past inputs. The RNN will address past and future measurements and make predictions based on this continuous measurement information. One type of RNN that may be used is a long short term memory (LSTM) neural network.

As indicated above, the AI model 760 may be one or more generative AI models, allowing for the generation of new and original content. The generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including recurrent neural networks (RNNs), convolutional neural networks (CNNs), or transformer networks.

Validation engine 724 may be capable of validating a trained model 760 using a corresponding set of features of a validation set from training set generator 712. The validation engine 724 may determine an accuracy of each of the trained models 760 based on the corresponding sets of features of the validation set. The validation engine 724 may discard a trained model 760 that has an accuracy that does not meet a threshold accuracy. In some embodiments, the selection engine 726 may be capable of selecting a trained model 760 that has an accuracy that meets a threshold accuracy. In some embodiments, the selection engine 726 may be capable of selecting the trained model 760 that has the highest accuracy of the trained models 760.

The testing engine 786 may be capable of testing a trained model 760 using a corresponding set of features of a testing set from training set generator 712. For example, a first trained model 760 that was trained using a first set of features of the training set may be tested using the first set of features of the testing set. The testing engine 728 may determine a trained model 760 that has the highest accuracy of all of the trained machine learning models based on the testing sets.

As described herein, predictive component 752 of server 750 (or another component of meeting resource engine 156) may be configured to feed data as input to model 760 and obtain one or more outputs. In some embodiments, predictive component 752 can include or be associated with security engine 152.

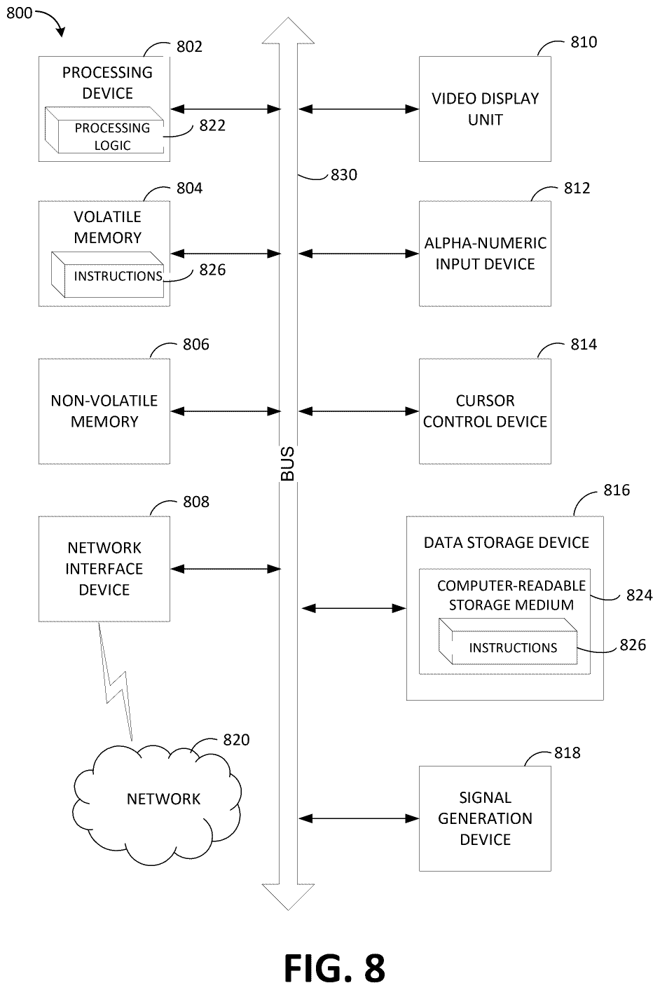

FIG. 8 is a block diagram illustrating an example computer system 800, in accordance with implementations of the present disclosure. The computer system 800 can correspond to computing device(s) 120, predictive system 180, and/or client device 102, described with respect to FIG. 1. Computer system 800 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device (processor) 802, a volatile memory 804 (e.g., read-only memory (ROM), flash memory, dynamic random access memory (DRAM) such as synchronous DRAM (SDRAM), double data rate (DDR SDRAM), or DRAM (RDRAM), etc.), a non-volatile memory 806 (e.g., flash memory, static random access memory (SRAM), etc.), and a data storage device 816, which communicate with each other via a bus 830.

Processor (processing device) 802 represents one or more general-purpose processing devices such as a microprocessor, central processing unit, or the like. More particularly, the processor 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 802 can also be one or more special-purpose processing devices such as an application specific integrated circuit (ASIC), a field programmable gate array (FPGA), a digital signal processor (DSP), network processor, or the like. The processor 802 is configured to execute processing logic 822 for performing the operations discussed herein.

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker).

The data storage device 816 can include a non-transitory machine-readable storage medium 824 (also computer-readable storage medium) on which is stored one or more sets of instructions 826 embodying any one or more of the methodologies or functions described herein. The instructions can also reside, completely or at least partially, within the volatile memory 804 and/or within the processor 802 during execution thereof by the computer system 800, the volatile memory 804 and the processor 802 also constituting machine-readable storage media. The instructions can further be transmitted or received over a network 820 via the network interface device 808.

In one implementation, the instructions 826 include instructions for providing fine-grained version histories of electronic documents at a platform. While the computer-readable storage medium 824 (machine-readable storage medium) is shown in an example implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, the use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include the collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
detecting a user query pertaining to one or more artificial intelligence (AI) models of a system, wherein each of the one or more AI models are supported by a plurality of services associated with the system, each of the plurality of services running via at least one computing resource;
receiving, from each computing resource running a respective service of the plurality of services, performance data reflecting a performance of an operation pertaining to the user query by the respective service and state data reflecting a state of the computing resource based on the performance of the operation;
generating a mapping between the performance data and the state data received from each computing resource; and
performing one or more of a threat detection operation or a security enforcement operation based on the generated mapping.

2. The method of claim 1, wherein the plurality of services comprise at least one of:
a preprocessing service that performs one or more preprocessing operations with respect to the user query,
a retrieval service that retrieves data pertaining to the user query from one or more data stores,
a model management service that identifies an AI model of the one or more AI model for forwarding of a prompt associated with the user query,
a resource management service that performs one or more of a compute provisioning operation, a load balancing operation, or a fault tolerance operation with respect to one or more AI models, or
a postprocessing service that performs one or more postprocessing operations with respect to the user query.

3. The method of claim 1, further comprising:
prior to detecting the user query, loading a code segment to each computing resource running the respective service of the plurality of services, wherein the code segment, when executed by each computing resource, collects the performance data and the state data and transmits the collected performance data and the state data to a data store associated with a security engine,
wherein the one or more of the threat detection operations or the security enforcement operations are performed by the security engine.

4. The method of claim 3, wherein the code segment corresponds to one or more of an extended Berkeley Packet Filter (eBPF) sensor, a proxy component, or a software development kit (SDK) component.

5. The method of claim 4, wherein the code segment corresponds to a proxy component, and wherein the method further comprises:
performing one or more deployment operations to deploy the code segment in a virtualized component hosted by each computing resource.

6. The method of claim 4, wherein the code segment corresponds to a SDK component, and wherein the method further comprises:
installing a SDK file at each computing resource.

7. The method of claim 1, wherein the performance data and the state data is received from each computing resource of the plurality of services through an application programming interface (API) call comprising the performance data and the state data.

8. The method of claim 1, wherein the performance data comprises at least one of an indication of an input of the operation pertaining to the user query or an indication of an output of the operation pertaining to the user query.

9. The method of claim 1, wherein the state data comprises telemetry data reflecting at least one of:
one or more of a software state of the respective service or a hardware state of the computing resource before the performance of the operation,
one or more of a software state of the respective service or a hardware state of the computing resource during the performance of the operation, or
one or more of a software state of the respective service or a hardware state of the computing resource after the performance of the operation.

10. The method of claim 1, wherein generating the mapping between the performance data and the state data received from each computing resource comprises:
updating the mapping to associate the performance data and the state data received from a first computing resource running a first service of the plurality of services to the performance data and the state data received from a second computing resource running a second service of the plurality of services.

11. The method of claim 1, wherein performing the threat detection operation based on the generated mapping comprises:
determining, based on the generated mapping, whether one or more anomaly criteria pertaining to the performance of the operation associated with at least one respective service of the plurality of services are satisfied; and
responsive to determining that the one or more anomaly criteria are satisfied, providing a notification of that the one or more anomaly criteria are satisfied to a client device associated with an operator of the system.

12. The method of claim 1, wherein performing the security enforcement operation comprises:
responsive to determining that one or more anomaly criteria pertaining to the performance of the operation associated with at least one respective service of the plurality of services are satisfied, performing at least one of a first blocking operation to block a prompt associated with the user query from being provided as an input to the one or more AI models or a second blocking operation to block a response to the user query from being provided to a client device that provided the user query.

13. The method of claim 1, wherein performing the security enforcement operation comprises:
updating a data store to store a notification that one or more anomaly criteria pertaining to the performance of the operation associated with at least one respective service of the plurality of services are satisfied;
detecting a subsequent user query pertaining to the one or more AI models of the system from a client device that provided the user query; and
performing at least one of a first blocking operation to block a prompt associated with the subsequent user query from being provided as an input to the one or more AI models or a second blocking operation to block a response to the subsequent user query from being provided to a client device that provided the user query.

14. A system comprising:
a memory; and
a set of one or more processing devices coupled to the memory, wherein the set of one or more processing devices is to perform operations comprising:
detecting a user query pertaining to one or more artificial intelligence (AI) models of a system, wherein each of the one or more AI models are supported by a plurality of services associated with the system, each of the plurality of services running via at least one computing resource;
receiving, from each computing resource running a respective service of the plurality of services, performance data reflecting a performance of an operation pertaining to the user query by the respective service and state data reflecting a state of the computing resource based on the performance of the operation;
generating a mapping between the performance data and the state data received from each computing resource; and
performing one or more of a threat detection operation or a security enforcement operation based on the generated mapping.

15. The system of claim 14, wherein the plurality of services comprise at least one of:
a preprocessing service that performs one or more preprocessing operations with respect to the user query,
a retrieval service that retrieves data pertaining to the user query from one or more data stores,
a model management service that identifies an AI model of the one or more AI model for forwarding of a prompt associated with the user query,
a resource management service that performs one or more of a compute provisioning operation, a load balancing operation, or a fault tolerance operation with respect to one or more AI models, or
a postprocessing service that performs one or more postprocessing operations with respect to the user query.

16. The system of claim 14, wherein the one or more operations comprise:
prior to detecting the user query, loading a code segment to each computing resource running the respective service of the plurality of services, wherein the code segment, when executed by each computing resource, collects the performance data and the state data and transmits the collected performance data and the state data to a data store associated with a security engine,
wherein the one or more of the threat detection operations or the security enforcement operations are performed by the security engine.

17. The system of claim 16, wherein the code segment corresponds to one or more of an extended Berkeley Packet Filter (eBPF) sensor, a proxy component, or a software development kit (SDK) component.

18. A non-transitory computer readable storage medium comprising instructions that, when executed by a processing device, cause the processing device to perform operations comprising:
detecting a user query pertaining to one or more artificial intelligence (AI) models of a system, wherein each of the one or more AI models are supported by a plurality of services associated with the system, each of the plurality of services running via at least one computing resource;
receiving, from each computing resource running a respective service of the plurality of services, performance data reflecting a performance of an operation pertaining to the user query by the respective service and state data reflecting a state of the computing resource based on the performance of the operation;
generating a mapping between the performance data and the state data received from each computing resource; and
performing one or more of a threat detection operation or a security enforcement operation based on the generated mapping.

19. The non-transitory computer readable storage medium of claim 18, wherein the plurality of services comprise at least one of:
a preprocessing service that performs one or more preprocessing operations with respect to the user query,
a retrieval service that retrieves data pertaining to the user query from one or more data stores,
a model management service that identifies an AI model of the one or more AI model for forwarding of a prompt associated with the user query,
a resource management service that performs one or more of a compute provisioning operation, a load balancing operation, or a fault tolerance operation with respect to one or more AI models, or
a postprocessing service that performs one or more postprocessing operations with respect to the user query.

20. The non-transitory computer readable storage medium of claim 18, wherein the operations further comprise:
prior to detecting the user query, loading a code segment to each computing resource running the respective service of the plurality of services, wherein the code segment, when executed by each computing resource, collects the performance data and the state data and transmits the collected performance data and the state data to a data store associated with a security engine,
wherein the one or more of the threat detection operations or the security enforcement operations are performed by the security engine.
